(19) United States
(12) Patent Application Publication
(10) Pub. No.: US 2026/0147709 A1
(43) Pub. Date: May 28, 2026

(54) METHOD AND APPARATUS FOR MINIMIZING DATA WRITES IN DATABASE USING NON-VOLATILE MEMORY

(71) Applicant: SEOUL NATIONAL UNIVERSITY R&DB FOUNDATION, Seoul (KR)

(72) Inventors: Sang-Won LEE, Seoul (KR); Jonghyeok PARK, Seoul (KR); Bo-Hyun LEE, Seoul (KR); Seongjae MOON, Seoul (KR)

(73) Assignee: SEOUL NATIONAL UNIVERSITY R&DB FOUNDATION, Seoul (KR)

(21) Appl. No.: 19/390,831

(22) Filed: Nov. 17, 2025

(30) Foreign Application Priority Data
Nov. 26, 2024 (KR) 10-2024-0170335

(51) Int. Cl. G06F 12/0802; G06F 3/06

(52) U.S. Cl. CPC G06F 12/0802; G06F 3/0604; G06F 3/0655; G06F 3/0679; G06F 2212/60

(57) ABSTRACT

A data write minimization apparatus according to one embodiment may perform caching a page stored in a storage device into a buffer of a volatile memory; generating, when a data update transaction occurs for the page, a PPL block including a per-page log (PPL), which is a per-page redo log, for the data update transaction in a non-volatile memory, and storing, when the PPL block grows larger than a preset size, an entire page in the storage device; and maintaining, when a page write occurs for a PPL page in which the redo log is stored as a PPL block in the non-volatile memory, the PPL block stored in the non-volatile memory, and performing, when a page write occurs for a normal page, an entire page write to the storage device.

### BACKGROUND OF THE INVENTION

### Field of the Invention

The present disclosure relates to a data storage and recovery technology in a database management system, and more particularly, to a technology for minimizing I/O occurring in an SSD and improving transaction processing performance by utilizing a non-volatile memory as a durable log cache.

Meanwhile, the present disclosure was supported by the following national research development projects.
Subject Identification Code: 2710009920
Grant Number: 2022R1A2C2008225
Name of Ministry: Ministry of Science and ICT
Name of Project Management Organization: National Research Foundation of Korea
Research Project Name: Individual Basic Research (Ministry of Science and ICT)
Research Subject Name: Development of NVDIMM-based high-performance transaction processing technology in a disaggregated data center.
Name of Project Performing Organization: Seoul National University
Research Period: Mar. 1, 2024 to Feb. 28, 2025

### Background of the Related Art

A non-volatile memory, which is a memory that maintains data even when power is cut off, unlike a volatile memory, it has characteristics that can retain data for a long period of time. The characteristics of the non-volatile memory play an important role in a database management system that frequently requires storage and analysis of large amounts of data.

In particular, the utilization of the non-volatile memory is increasing in a database management system to ensure data durability and improve write performance. Additionally, in the data center and cloud computing fields, high-performance data processing and long-term data retention are essential, and thus, the adoption of the non-volatile memory as an efficient storage device is increasing.

Meanwhile, an existing database management system primarily uses DRAM as a caching buffer to ensure data persistence in various workloads such as on-line transaction processing (OLTP) and online analytical processing (OLAP), and adopts a structure that stores data in a storage device such as a solid state drive (SSD).

In this case, in the existing database management system, DRAM, which is a volatile memory, cannot retain data when power is turned off, and therefore, data is recorded on the SSD at a high frequency to ensure data durability to prevent data loss in the event of a system failure. In this process, redo logs and undo logs are managed separately on the SSD, and necessary data is recorded on the SSD whenever a transaction occurs, thereby maintaining data integrity and consistency.

Although the existing database management system can ensure data stability, there are several problems.

First, because write operations to an SSD occur at a high frequency, it has a problem in that durability deteriorates quickly, and the lifespan of the storage device is shortened as long-term write operations accumulate. In particular, when a small amount of data is frequently updated in a short interval, such as OLTP workloads, there is a problem in that the performance of the entire system deteriorates as write operations to the SSD become more frequent. In this case, overwriting is impossible due to the nature of the SSD, and write overhead occurs because data is internally processed using a Copy on Write (CoW) method, which also adversely affects transaction processing performance.

Second, in the event of a system failure, a lot of I/O operations occur in a process of recovering pages in an SSD, so there is a problem of long recovery times based on Algorithms for Recovery and Isolation Exploiting Semantics (ARIES) using redo and undo logs. That is, in the event of a system failure in the existing database management system, frequent I/O operations occur on the SSD to recover all transactions, which results in a delay in recovery time.

Third, NV-SQL, a database management system that uses a non-volatile memory, is designed to cache data in the non-volatile memory in units of pages according to a registration policy to ensure data durability. This method can prevent data loss while maintaining data consistency, but inefficiency occurs because the entire page must be stored in the non-volatile memory, even if a very small size of data modification occurs as it is stored in units of pages.

In order to solve such problems, the present disclosure presents a database management system that utilizes the non-volatile memory as a durable log cache so as to propose a technology for minimizing write operations to the SSD and improving transaction processing performance.

### CITATION LIST

### Patent Literature

Korean Patent No. 10-1946135

### SUMMARY OF THE INVENTION

The present disclosure aims to solve the tasks of minimizing write operations occurring in a database, ensuring data durability, and significantly improving recovery performance by utilizing a non-volatile memory as a durable log cache of a database system.

To this end, the present disclosure aims to store, whenever an update occurs in a buffer of the volatile memory, a redo log of the corresponding update in the non-volatile memory, thereby maintaining data durability without I/O in an SSD even in the event of a system failure. This method reduces frequent write operations that occur in an existing database so as to make the most of the characteristics of an SSD with better read performance than write performance and extend the lifespan of the SSD.

Furthermore, the present disclosure aims to place a redo log buffer and a double write buffer (DWB) in the non-volatile memory to reduce a duplicated write count occurring from the volatile memory to an SSD and minimize necessary write operations, thereby improving a transaction processing speed. Through this, the present disclosure aims to efficiently manage frequent I/O operations occurring within a database and improve transaction processing performance.

In the present disclosure addition, aims to significantly reduce I/O in redo and undo processes by utilizing a redo log stored in the non-volatile memory even during recovery, thereby shortening recovery time. In particular, the present disclosure provides a recovery structure that can utilize page-by-page redo logs stored in the non-volatile memory to quickly restore consistency even after a system failure and improve the performance of both OLTP and OLAP even in HTAP workloads, thereby improving system availability.

Moreover, the present disclosure aims to improve a performance degradation problem that occurs in an existing undo-based multi-version management method when performing an OLAP query that caches a large amount of data, such as a long-living transaction (LLT), in the volatile memory. To this end, the present disclosure aims to generate redo-based multiple versions in the non-volatile memory to quickly configure required data versions, thereby reducing query response time, and simultaneously improving the transaction processing performance of OLAP and OLTP.

Meanwhile, technical problems of the present disclosure are not limited to the above-mentioned problems, and other technical problems which are not mentioned herein will be clearly understood by those skilled in the art from the description below.

A method performed by a data write minimization apparatus operated by a processor according to one embodiment may include caching a page stored in a storage device into a buffer of a volatile memory; generating, when a data update transaction occurs for the page, a PPL block including a per-page log (PPL), which is a per-page redo log, for the data update transaction in a non-volatile memory, and storing, when the PPL block grows larger than a preset size, an entire page in the storage device; and maintaining, when a page write occurs for a PPL page in which the redo log is stored as a PPL block in the non-volatile memory, the PPL block stored in the non-volatile memory, and performing, when a page write occurs for a normal page, an entire page write to the storage device.

Furthermore, the storing may include storing, when a data update transaction for the page occurs a plurality of times, each PPL, which is a per-page redo log for the plurality of data update transactions, in a PPL block in an update time sequence.

Furthermore, the non-volatile memory may dynamically allocate a storage space of a PPL block to dynamically store a plurality of PPLs, wherein the PPL block includes metadata for a page and a plurality of PPLs, which are per-page redo logs for a plurality of data update transactions.

Furthermore, the meta data may include a flag (first_mark) indicating a first generated PPL block for a PPL page, a flag (normalize_mark) indicating whether normalization has been performed for the PPL page, a pointer (next_block) indicating an address of a next PPL block, a total length of PPLs (PPL_len) stored in all PPL blocks, a log sequence number (page_lsn) of a latest PPL added to a current PPL block, and a unique page number (page_id) specifying a PPL page.

Furthermore, the storing to the storage device may include performing a normalization process of erasing, when a size of an entire PPL block for one page becomes above a preset value, all redo logs included in the entire PPL block and storing an entire page reflecting all redo logs in the storage device to change a PPL page into a normal page.

Furthermore, the storing may include calculating a memory allocation rate for a non-volatile memory for each PPL page at preset intervals, and performing, when the memory allocation rate exceeds a preset threshold, a normalization process of erasing, when a last update to the page occurred before a preset time, all redo logs included in an entire PPL block and storing an entire page in the storage device to change a PPL page into a normal page.

Furthermore, the preset time of the last update for the page may be calculated according to Equation 1 below:

$$\frac{Pages per MB of Memory}{IOPS of Disk} \times \frac{Disk Price}{Memory Price per MB} \qquad [ Equation 1 ]$$

(Pages per MB of Memory: A number of pages that can be cached per 1 MB of memory, IOPS of Disk: A number of input/output operations that a disk can process per second, Disk Price/Memory Price per MB: A cost-performance efficiency between a disk and a memory).

Furthermore, the storing may include generating a lookup table, which is an in-memory hash table that stores a unique page number specifying a PPL page and a pointer specifying an address of a first generated PPL block as a key-value pair, in the volatile memory.

Furthermore, the generating of the lookup table may include adding, when a normal page is PPLized to become a PPL page, a unique page number specifying the PPL page and a pointer to the first generated PPL block to the lookup table.

Furthermore, the method may further include retrieving, when a read transaction occurs for a specific page, a unique page number for the specific page in the lookup table to determine, when the unique page number exists in the lookup table, the specific page as a PPL page, and determine, when the unique page number does not exist, the specific page as a normal page.

Furthermore, the storing may perform a double write buffer technique that doubly stores entire updated page contents in a buffer of the non-volatile memory and in the storage device.

Furthermore, the method may further include generating, when a read transaction occurs for the PPL page, a latest version of the PPL page reflecting the PPL stored in the non-volatile memory on a version of the PPL page stored in the storage device to cache it in a buffer of the volatile memory.

Furthermore, the generating of the latest version of the PPL page to cache it in a buffer of the volatile memory may include reflecting a PPL stored in the PPL block in a time sequence on a version of the PPL page stored in the storage device to generate a latest version of the PPL page.

Furthermore, the method may further include distinguishing, when an abnormal termination occurs, whether the abnormally terminated page is a normal page or a PPL page, to perform recovery.

Furthermore, the performing of the recovery may include retrieving a unique page number previously stored in a PPL block of the non-volatile memory and an address of a first generated PPL block to reconstruct a lookup table, which is an in-memory hash table that stores the retrieved unique page number and a pointer specifying the address of the first generated PPL block as a key-value pair, in the volatile memory; checking the lookup table based on a unique page number of the abnormally terminated page to distinguish whether the abnormally terminated page is a normal page or a PPL page; and performing recovery of the abnormally terminated page using a redo log or PPL based on the distinguishment.

Furthermore, the performing of recovery of the abnormally terminated page may include updating, when a normalization operation to store an entire normalized PPL page in the storage device fails due to an abnormal termination, the abnormally terminated PPL page by applying a latest PPL starting from a first PPL stored in the non-volatile memory, and restoring an original page by applying a log of a WAL file from a point in time after the latest PPL.

Furthermore, the method may include reflecting, when a request for generating a past version of a PPL page occurs, a PPL stored in the non-volatile memory up to a version set by a user on a version of the PPL page stored in the storage device to generate the past version of the PPL page.

Furthermore, the method may include generating, when a request for generating a past version of a PPL page occurs, the past version of the page using a WAL file stored in the storage device.

A data write minimization apparatus according to one embodiment may include a memory including an instruction; and a processor that performs a predetermined operation based on the instruction, wherein the operation of the processor includes caching a page stored in a storage device into a buffer of a volatile memory; generating, when a data update transaction occurs for the page, a PPL block including a per-page log (PPL), which is a per-page redo log, for the data update transaction in a non-volatile memory, and storing, when the PPL block grows larger than a preset size, an entire page in the storage device; and maintaining, when a page write occurs for a PPL page in which the redo log is stored as a PPL block in the non-volatile memory, the PPL block stored in the non-volatile memory, and performing, when a page write occurs for a normal page, an entire page write to the storage device.

A computer program stored in a non-transitory computer-readable recording medium according to one embodiment may include, when performed on at least one processor, an instruction that allows the processor to perform caching a page stored in a storage device into a buffer of a volatile memory; generating, when a data update transaction occurs for the page, a PPL block including a per-page log (PPL), which is a per-page redo log, for the data update transaction in a non-volatile memory, and storing, when the PPL block grows larger than a preset size, an entire page in the storage device; and maintaining, when a page write occurs for a PPL page in which the redo log is stored as a PPL block in the non-volatile memory, the PPL block stored in the non-volatile memory, and performing, when a page write occurs for a normal page, an entire page write to the storage device.

The present disclosure may utilize a non-volatile memory as a durable log cache of a database management system, thereby providing the following effects.

Specifically, the present disclosure may store update information of pages cached in a buffer of a volatile memory in a non-volatile memory to minimize write operations to a database, thereby significantly improving the overall transaction processing performance of a system. This reduces I/O overhead caused by frequent database writes and extends the lifespan of an SSD, which may reduce a maintenance cost in a large-scale system such as a data center.

Furthermore, the present disclosure may place a redo log buffer and a double write buffer (DWB) in a non-volatile memory to ensure data durability while reducing a duplicated write count occurring in an SSD (or storage device). Through this, a number of I/Os performed during a process of storing data in a database may be reduced, thereby expecting an effect of shortening a transaction latency and increasing a data storage efficiency.

In addition, the present disclosure may significantly improve recovery performance. In particular, in the event of a system failure, recovery time may be minimized by utilizing redo logs stored in a non-volatile memory to omit or shorten redo and undo steps. Accordingly, the present disclosure may reduce a large number of I/O operations that occur in traditional ARIES-based recovery methods to improve recovery performance and significantly enhance system availability.

Additionally, the present disclosure may improve the performance of both OLTP and OLAP even in HTAP workloads. In particular, when caching a large amount of data such as a long-living transaction (LLT) in a volatile memory, the present disclosure may quickly generate multiple versions by utilizing page-by-page redo logs stored in a non-volatile memory, thereby reducing I/O for undo pages and increasing a buffer hit rate of the volatile memory so as to provide data for past versions in a shorter period of time. Through this, the present disclosure has an effect capable of minimizing interference between OLTP and OLAP queries to optimize the performance of HTAP workloads.

Accordingly, the present disclosure may reduce write operations, shorten recovery time, improve transaction processing performance, extend the lifespan of an SSD, and provide performance optimized for HTAP workloads in a database system, thereby comprehensively improving the stability and performance of a database.

Meanwhile, the effects of the present disclosure may not be limited to the above-mentioned effects, and other technical effects which are not mentioned herein will be clearly understood by those skilled in the art from the description below.

### BRIEF DESCRIPTION OF THE DRAWINGS

FIG. 1 is a configuration diagram of a data write minimization apparatus according to one embodiment.

FIG. 2 is a flowchart showing steps of an operation performed by a data write minimization apparatus according to one embodiment.

FIG. 3 is a conceptual diagram simply showing a flow of data processed by the data write minimization apparatus according to the operation of FIG. 2.

FIG. 4 is an exemplary diagram of a PPL block and a data structure of a PPL according to one embodiment.

FIG. 5 is an exemplary diagram showing a relationship between a lookup table and a PPL block stored in a non-volatile memory according to one embodiment.

FIG. 6 is a flowchart of an operation performed by a data write minimization apparatus according to one embodiment when a read transaction occurs.

FIG. 7 is a conceptual diagram simply showing a flow of data processed by the data write minimization apparatus according to the operation of FIG. 6.

FIG. 8 is a flowchart of an operation performed by a data write minimization apparatus according to one embodiment when an abnormal termination occurs.

FIG. 9 is a flowchart of an operation performed by a data write minimization apparatus according to one embodiment when a request for generating a past version of a specific tuple occurs.

FIG. 10 is a conceptual diagram simply showing a flow of data processed by the data write minimization apparatus according to the operation of FIG. 9.

FIGS. 11A-11C are a performance comparison table comparing an existing technology and an embodiment of the present disclosure from various perspectives.

FIGS. 12A-12B are a performance comparison table comparing a long-lived transaction (LLT) latency and an online transaction processing (OLTP) throughput in systems configured with Vanilla, NV-PPL, and PPL-MV.

### DETAILED DESCRIPTION OF THE PREFERRED EMBODIMENT

The details of the objectives and technical configurations of the present disclosure and operational effects thereof will be more clearly understood from the following detailed description based on the accompanying drawings appended hereto. Hereinafter, embodiments according to the present disclosure will be described in detail with reference to the accompanying drawings.

Embodiments disclosed herein should not be interpreted as limiting or used to limit the scope of the present disclosure. It is apparent for those skilled in the art that a description including embodiments herein has various applications. Therefore, any embodiments described in the detailed description of the present disclosure are illustrative for better understanding of the present disclosure and are not intended to limit the scope of the present disclosure to the embodiments.

Functional blocks illustrated in the drawings and described hereunder are only examples of possible implementations. In other implementations, other functional blocks may be used without departing from the concept and scope of the detailed description. Furthermore, one or more functional blocks of the present disclosure are illustrated as separate blocks, but one or more of the functional blocks of the present disclosure may be a combination of various hardware and software elements that execute the same function.

In addition, an expression that some elements are “included” is an expression of an “open type”, and the expression simply denotes that the corresponding elements are present, but should not be construed as excluding additional elements.

Moreover, in case where it is mentioned that one element is “connected” or “coupled” to the other element, it should be understood that one element may be directly connected to the other element, but another element may be present therebetween.

Hereinafter, various embodiments of the present disclosure will be described with reference to the accompanying drawings. However, it should be understood that the embodiments are not intended to limit the present disclosure to specific embodiments, and include various modifications, equivalents, and/or alternatives of the embodiments of the present disclosure.

The present disclosure relates to a data storage and recovery technology in a database management system, and more particularly, proposes a data write minimization apparatus 100 that utilizes a non-volatile memory as a durable log cache to minimize I/O occurring in an SSD and improve transaction processing performance.

Hereinafter, a configuration of the data write minimization apparatus 100 of the present disclosure and an operation of each components will be examined.

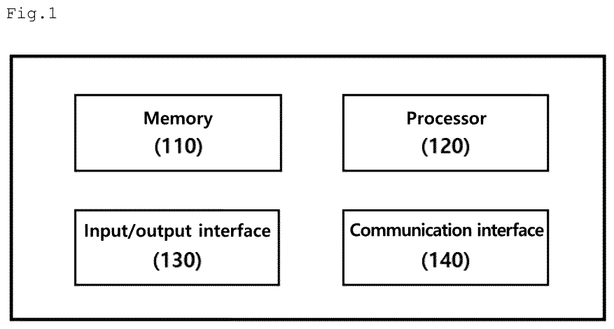

FIG. 1 is a configuration diagram of the data write minimization apparatus 100 (hereinafter, referred to as an ‘apparatus 100’) according to one embodiment.

Referring to FIG. 1, the apparatus 100 according to one embodiment may each include a memory 110, a processor 120, an input/output interface 130, and a communication interface 140.

The memory 110 may store data acquired from an external device or data generated by itself. The memory 110 may store instructions that can perform an operation of the processor 120. For example, the memory 110 may include a non-volatile memory, a volatile memory, and a storage device.

The non-volatile memory refers to a memory that maintains data even when power is turned off. The non-volatile memory retains data even when the system is turned off, and thus is used when permanent storage of data is required. For example, the non-volatile memory may include an NVDIMM, or the like. In an embodiment of the present disclosure, the non-volatile memory may be utilized as a durable log cache in a database management system.

A volatile memory refers to a memory in which the stored data disappears when power is cut off. The volatile memory provides fast read/write speeds, thus making it suitable for storing temporary data while the system is operating. For example, the volatile memory may include a dynamic random access memory (DRAM), a static random access memory (SRAM), or the like. In an embodiment of the present disclosure, the volatile memory retrieves data of an operating program from a database and temporarily caches the data to allow the processor to quickly access the data.

A storage device may act as a database, thus allowing various data management and access. For example, the storage device may include a disk storage device such as an HDD, SSD, or a cloud-based storage device. In an embodiment of the present disclosure, the storage device may support efficient access to specific data required by the processor 120, and operate as a database used to store, manage, and retrieve data in various applications.

The processor 120 is a calculation device that controls an overall operation. The processor 120 may execute instructions stored in the memory 110. The operation of a user terminal 10 and the apparatus 100 according to an embodiment of the disclosure may be understood as an operation performed by the processor 120.

The input/output interface 130 may include a hardware interface or software interface that inputs and outputs information.

The communication interface 140 allows information to be transmitted and received through a communication network. To this end, the communication interface 140 may include a wireless communication module or a wired communication module.

The apparatus 100 may be implemented as various types of apparatuses capable of performing calculations through the processor 120 and transmitting and receiving information through a network. For example, it may be implemented in a form of a server, a computer device, a portable communication device, a smart phone, a portable multimedia device, a laptop, a tablet PC, and the like, but is not limited to those examples.

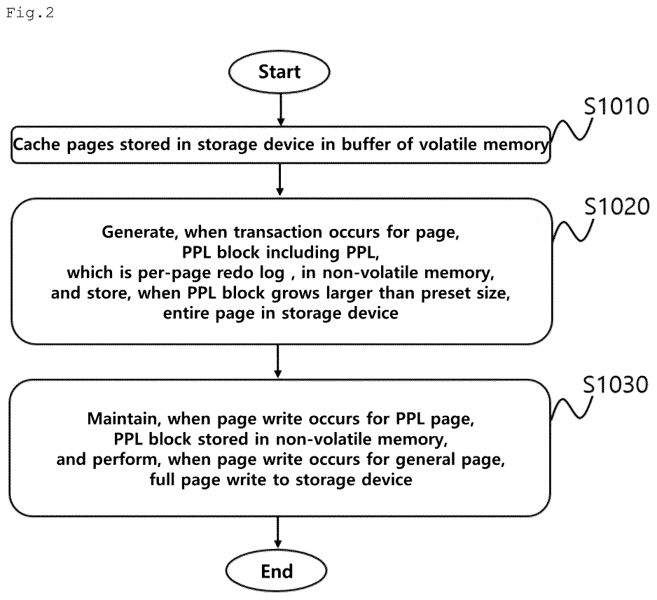

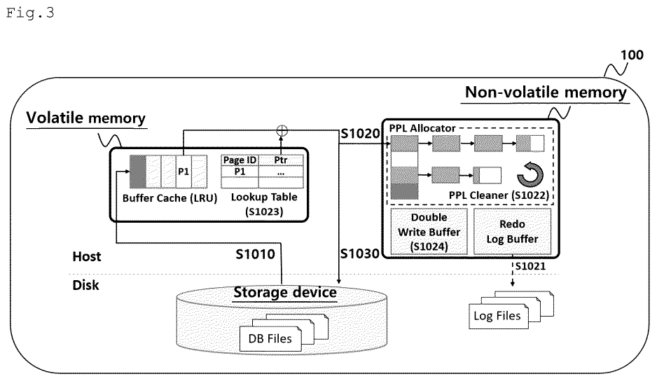

FIG. 2 is a flowchart of an operation performed by the apparatus 100 according to one embodiment. FIG. 3 is a conceptual diagram simply showing a flow of data processed by the apparatus 100 according to the operation of FIG. 2. The operation of the apparatus 100 according to an embodiment in FIGS. 2 and 3 may be understood as an operation performed by the processor 120.

Each step disclosed in FIGS. 2 and 3 is only a preferred embodiment in achieving the objectives of the present disclosure, and some steps may be added thereto or deleted therefrom as needed, and any one step may be included in another step to be performed. The order of respective operations disclosed in FIGS. 2 and 3 is only arranged for convenience of understanding, and such an order is not limited to a time series order, and the order may be changed and operated differently depending on the designer's choice.

Referring to FIGS. 2 and 3 together, in step S1010, the apparatus 100 may cache pages stored in a storage device (e.g., SSD) in a buffer of the volatile memory (e.g., DRAM) for data operations (e.g., reading, updating, writing, etc.). Here, a page is a unit of storage structure that specifies a size to be cached in the volatile memory for operating on data stored in a database.

Meanwhile, step S1010 may include a step in an initial state in which page-related log information is not yet stored in the non-volatile memory (e.g., NVDIMM) as the operations of FIGS. 2 and 3 are executed for the first time.

Additionally, step S1010 may include a step in which the operations of FIGS. 2 and 3 are executed again subsequent to having been previously executed at least once before, and page-related log information is stored in the non-volatile memory. In this case, depending on a type of page to be loaded into a buffer of the volatile memory, the apparatus 100 may cache the page stored in the storage device in the buffer in a manner of steps S2010 to S2030 to be described later.

Subsequent to performing the operation of step S1010, in the case of an existing database management system, whenever a transaction occurs for a page cached in a buffer of the volatile memory, log information on the transaction is stored in a storage device, and pages on which updates have occurred are stored in the storage device in units of pages in order to ensure durability of the page in the future. In particular, when a small amount of data is frequently updated, it has a problem in that the durability of the storage device deteriorates quickly because page write operations to the storage device occur at a high frequency.

Accordingly, the present disclosure presents a method of utilizing a non-volatile memory as a durable log cache as described below, and stores log information in a storage device only when a specific condition is satisfied. As the present disclosure presents such a framework, the terms to be used in the following description will first be defined.

A ‘PPL’ is an abbreviation for a per-page log, and refers to a file that includes a redo log that is stored in a non-volatile memory instead of writing changes to pages directly to a storage device. That is, in order to distinguish between a redo log stored in the non-volatile memory and a redo log stored in the storage device, in the description of the present disclosure, a redo log stored in the non-volatile memory is referred to as a PPL.

A ‘PPL block’ refers to a storage block allocated to store a PPL in the non-volatile memory.

A ‘PPL page’ refers to a page where a redo log is stored in the non-volatile memory in a form of PPL.

A ‘normal page’ is a page where a redo log is recorded directly on the storage device. That is, a normal page refers to a page where a redo log is not stored in the non-volatile memory in a form of PPL.

That is, both a ‘normal page’ and a ‘PPL page’ are stored in a storage device, but in the description of the present disclosure, the types of pages are distinguished based on whether the redo log is stored in the non-volatile memory in the form of PPL. When the redo log is not stored in the non-volatile memory in the form of PPL, it is distinguished as a ‘normal page’, and when the redo log for the page is stored in the non-volatile memory as a PPL, it is distinguished as a ‘PPL page’.

A ‘PPLization’ refers to a process of converting a normal page into a PPL page. A specific example of PPLization will be described in step S1020 of FIGS. 2 and 3 to be described later.

‘Normalization’ refers to a process of converting a PPL page back to a normal page. A specific example of normalization will be described in steps S1021 and S1022 of FIGS. 2 and 3 to be described later.

In step S1020, when a data update transaction (e.g., insert, delete, update) occurs for a page, the apparatus 100 may generate a PPL block including a PPL, which is a per-page redo log for the data update transaction, in the non-volatile memory. In this case, when a redo log of a normal page is stored in the non-volatile memory for the first time, from this time on, the corresponding page is PPLized, and classified as a PPL page, not a normal page.

In addition, in step S1020, when a data update transaction for the corresponding page occurs a plurality of times, the apparatus 100 may generate a PPL, which is a per-page redo log for each of the plurality of data update transactions, and store each PPL in an update time sequence.

However, in the case of a data update transaction for a normal page, a redo log for the data update transaction is stored separately in the volatile memory. However, accumulated redo logs are stored until a size thereof is smaller than a maximum value for a PPL block to be described later, and when a write request is made for the normal page, the size of the accumulated redo logs is checked to copy the accumulated redo logs in the volatile memory to the non-volatile memory in the form of PPL so as to carry out PPLization.

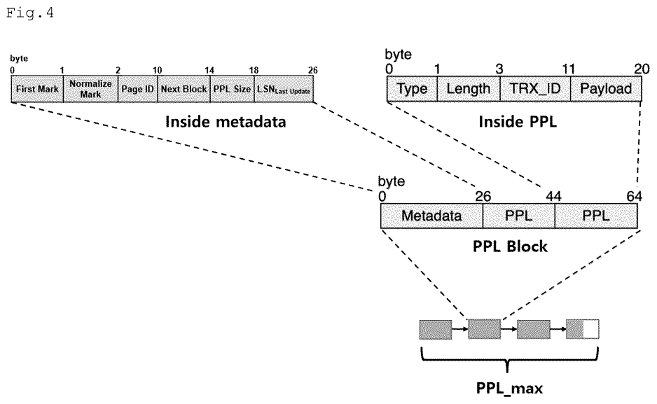

The specific configuration of a PPL block and a PPL is as shown in FIG. 4 below.

FIG. 4 is an exemplary diagram of a PPL block and a data structure of a PPL according to one embodiment.

Referring to FIG. 4, a PPL block is a data structure that stores a plurality of PPLs generated based on one page, and the apparatus 100 may dynamically allocate a storage space of a non-volatile memory to the PPL block to store the plurality of PPLS.

As an example, a PPL block may include metadata specifying one page and one or more PPLs, which are redo logs for transactions generated based on one page.

Here, the metadata of the PPL block may include a flag (first_mark) indicating a first generated PPL block for a PPL page, a flag (normalize_mark) indicating whether normalization has been performed for the PPL page, a pointer (next_block) indicating an address of a next PPL block, a total length (PPL_len) of PPLS stored in all PPL blocks, a log sequence number (page_lsn) of a latest PPL added to a current PPL block, and a unique page number (page_id) specifying a PPL page. Additionally, the PPL of the PPL block may include information on a payload including a log type, a log length, a transaction ID, and a redo log.

Meanwhile, a maximum value for one PPL block may be preset. In this case, when the amount of data stored in the PPL block reaches a preset maximum value as PPLs are accumulated and stored in one PPL block, the apparatus 100 may generate a new PPL block. The apparatus 100 may link a newly generated PPL block and a previously generated PPL block in a generation sequence through a pointer based on one page.

Specifically, when adding a PPL to a PPL block, the apparatus 100 may atomically write a log by adding a header (a log type, a log length, a transaction ID) and a payload of the PPL to an end of a current PPL block and then updating PPL_len in a first PPL block. In this case, in order to ensure cache consistency and durability, the apparatus 100 may call commands clflush and mfence after writing the PPL. Accordingly, since PPL_len is stored directly in the metadata, it is sufficient to apply a log as much as PPL_len without having to inspect a valid PPL during recovery. If the remaining space in the PPL block is smaller than a size of a PPL that needs to be newly generated, then a new PPL block is allocated and the PPL is stored over several blocks. In order to ensure that a PPL is not partially stored, a PPL_len field in the metadata may be updated to a new length only after the PPL has been completely written to the PPL block.

In addition, as step S1021 that can be additionally executed during step S1020, the apparatus 100 may erase, when a sum of a size of an entire PPL block generated for one page becomes larger than a preset size (e.g., PPL max in FIG. 4, hereinafter referred to as ‘PPL max’), all redo logs included in the entire PPL block and store an entire page in a storage device. As described above, that is, as an entire page on which all redo logs of the corresponding page are reflected is stored back in the storage device, a normalization operation is performed in which a PPL page is changed to a normal page.

That is, the reason for setting PPL max, which is a size of an entire PPL block that can be allocated for one page, is to prevent pages with excessive redo logs from being PPLized, and inefficiently using a limited space of the non-volatile memory. For example, one page with a cumulative redo log size of 512 bytes and eight pages with a redo log size of 64 bytes will require the same space of 512 B of the non-volatile memory when a page write occurs in both cases. However, allocating 512 B of space to 8 pages with 64-byte redo logs may absorb 8 times more writes than allocating it to one page. Therefore, in order to reduce more page writes to the same space, PPLization may be carried out based on a threshold of PPL max, and PPL max may be set to 256 bytes by default. This is because for most workloads, more than 80% of page writes generates a redo log of 256 bytes or less.

In addition, as step S1022 that can be additionally executed during step S1020, the apparatus 100 may calculate a memory allocation rate for a non-volatile memory for each PPL page at preset intervals, and perform, when the memory allocation rate exceeds a preset threshold, a normalization process of erasing, when a last update to the page occurred before a preset time, all redo logs included in an entire PPL block, and storing an entire page reflecting the redo logs in the storage device to change a PPL page into a normal page. Accordingly, the apparatus 100 may perform a normalization process of deleting a PPL block stored for the corresponding page in the non-volatile memory to change a PPL page into a normal page.

For example, the apparatus 100 may calculate a preset time of a last update for a page using Equation 1 below.

$$\frac{Pages per MB of Memory}{IOPS of Disk} \times \frac{Disk Price}{Memory Price per MB} \qquad [ Equation 1 ]$$

(Pages per MB of Memory: A number of pages that can be cached per 1 MB of memory, IOPS of Disk: A number of input/output operations that a disk can process per second, Disk Price/Memory Price per MB: A cost-performance efficiency between a disk and a memory).

That is, step S1022 operates to solve the problem that writes cannot be reduced due to a lack of available PPL blocks as many pages are PPLized. For example, the apparatus 100 may calculate a memory allocation rate of each PPL page at preset intervals (e.g., every 5 minutes), and determine, when the calculated memory allocation rate exceeds a threshold (e.g., 95%), and when the last update of the PPL page is earlier than the preset time, that the corresponding PPL page has not used a PPL for a long time, and transfer a redo log of the non-volatile memory for the corresponding PPL page to a storage device to normalize it, and recover the space of the PPL block that has been allocated to the non-volatile memory for the corresponding page.

In addition, as step S1023 that can be additionally executed during step S1020, the apparatus 100 may generate a lookup table, which is an in-memory hash table that stores a unique page number specifying a PPL page and a pointer specifying an address of a first generated PPL block as a key-value pair, in the volatile memory.

For example, when a normal page is PPLized into a PPL page, the apparatus 100 may add and manage a unique page number specifying the corresponding PPL page and a pointer of the first generated PPL block to a lookup table.

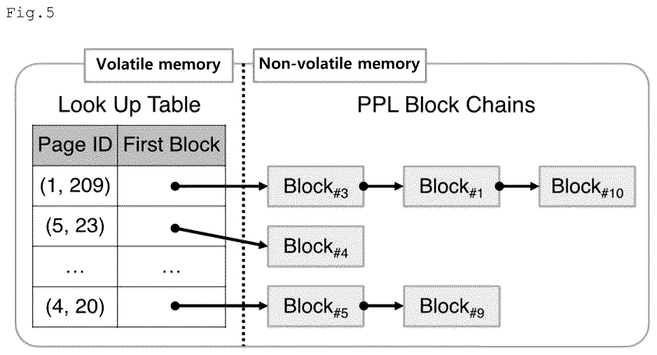

FIG. 5 is an exemplary diagram showing a relationship between a lookup table and a PPL block stored in a non-volatile memory according to one embodiment.

Referring to FIG. 5, the lookup table may be stored in the volatile memory, and managed by linking each page ID and an address of a first PPL block for the corresponding page. For example, page ID (1, 209) is linked to an address of Block #3, page ID (5, 23) is linked to an address of Block #4, and page ID (4, 20) is linked to an address of Block #5.

Starting with an address of a first PPL block referenced in the lookup table, addresses of the PPL blocks are linked in a chain in the non-volatile memory. For example, each PPL block includes an address of a next block as a pointer, so that they can be linked in a chain, and thus the update history of the page may be stored sequentially. In the case of FIG. 5, Block #3 forms a chain leading to Block #1 and Block #10, and Block #5 is linked to Block #9.

In this way, the apparatus 100 may quickly look up the location of the first PPL block where each page starts through the lookup table, and sequentially check all update history for the page by following the chain structure. This may help effectively track and recover the latest status and change history of each page in a log management and recovery operation by utilizing a PPL method. As an example, when a read transaction occurs for a specific page, the apparatus 100 may retrieve a unique page number for the corresponding page from the lookup table to determine, when the unique page number exists in the lookup table, the corresponding page as a PPL page, and determine, when it does not exist, the corresponding page as a normal page.

In addition, as step S1024 that can be additionally executed during step S1020, the apparatus 100 may perform a double write buffer technique that doubly stores entire updated page contents in a buffer of the non-volatile memory and in the storage device. Conventional double-write buffers only store the entire updated page contents in duplicate on a storage device, but in the case of an embodiment of the present disclosure, instead of recording the updated contents twice on a storage device, the durability of the page may be maintained by writing once to a buffer of the non-volatile memory, and recording once on the storage device, and a number of I/Os required for synchronization and a duplicated write count of pages to a storage device may be reduced by half.

When a page write occurs for a PPL page, in step S1030, the apparatus 100 maintains a PPL block stored in the non-volatile memory and does not perform a separate data write to the storage device. That is, in the case of a PPL page, a redo log for all updates to the page is stored in the non-volatile memory, so there is no need to write to the storage device.

Meanwhile, when a page write occurs for a normal page, in step S1030, the apparatus 100 may perform a full page write to the storage device as in a general case.

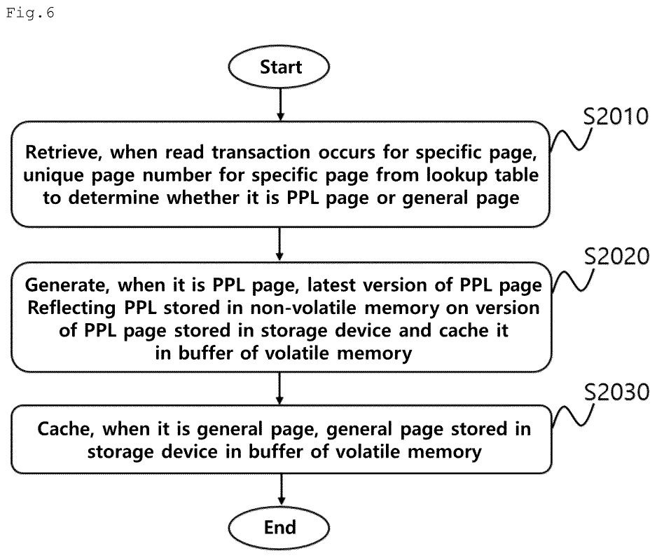

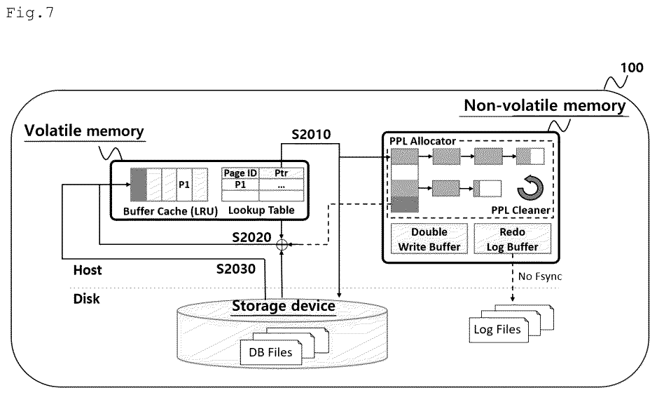

That is, according to step S1030, it is possible to reduce page writes from the volatile memory to the storage device, improve transaction processing performance, extend the lifespan of the SSD, and utilize the characteristics that a read speed is faster than a write speed. A specific operation for improving a read speed will be described with reference to FIGS. 6 and 7.

FIG. 6 is a flowchart of an operation performed by the apparatus 100 according to one embodiment when a read transaction occurs. FIG. 7 is a conceptual diagram simply showing a flow of data processed by the apparatus 100 according to the operation of FIG. 6. The operation of the apparatus 100 according to an embodiment in FIGS. 6 and 7 may be understood as an operation performed by the processor 120.

Each step disclosed in FIGS. 6 and 7 is only a preferred embodiment in achieving the objectives of the present disclosure, and some steps may be added thereto or deleted therefrom as needed, and any one step may be included in another step to be performed. The order of respective operations disclosed in FIGS. 6 and 7 is only arranged for convenience of understanding, and such an order is not limited to a time series order, and the order may be changed and operated differently depending on the designer's choice.

Referring to FIGS. 6 and 7 together, when a read transaction occurs for a specific page, in step S2010, the apparatus 100 may retrieve a unique page number for the specific page from a lookup table to determine whether it is a PPL page or a normal page.

For example, when a read transaction occurs for a specific page, the apparatus 100 may retrieve a unique page number for the corresponding page from the lookup table to classify, when the unique page number exists in the lookup table, the corresponding page as a PPL page, and classify, when it does not exist, the corresponding page as a normal page.

When the page on which the read transaction has occurred is classified as a PPL page, in step S2020, the apparatus 100 may generate a latest version of the PPL page reflecting a PPL stored in the non-volatile memory on a version of PPL page stored in the storage device and cache it in a buffer of the volatile memory.

For example, the apparatus 100 may obtain an address of a first PPL block of the corresponding PPL page through the lookup table, and then apply all PPLs stored in the first PPL block to a version of the PPL page read from the storage device. Subsequently, the apparatus 100 may sequentially apply all PPLs stored in a next generated PPL block along a pointer stored in next_block from among the metadata of the first PPL block. Continuously, the apparatus 100 may sequentially apply all PPLs stored in all PPL blocks using a pointer stored in next_block to generate a latest version of the PPL page so as to cache it in a buffer of the volatile memory.

When the page on which the read transaction has occurred is classified as a normal page, in step S2030, the apparatus 100 may cache the normal page stored in the storage device in the buffer of volatile memory, as in a conventional caching method.

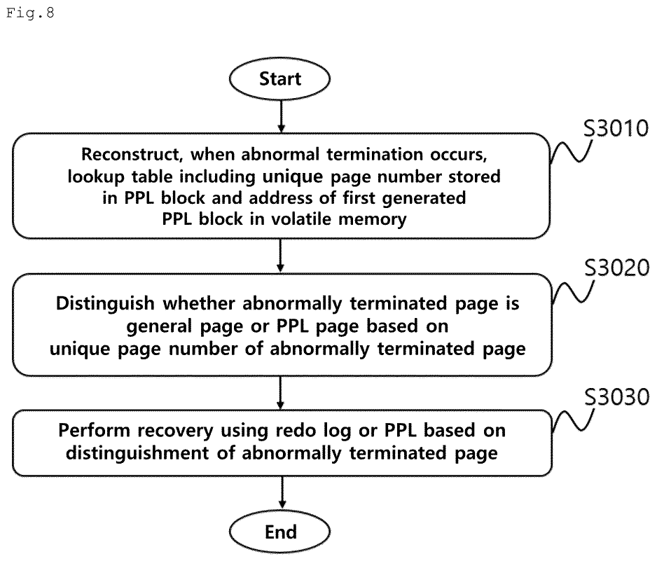

FIG. 8 is a flowchart of an operation performed by the apparatus 100 according to one embodiment when an abnormal termination occurs. The operation of the apparatus 100 according to an embodiment in FIG. 8 may be understood as an operation performed by the processor 120.

Each step disclosed in FIG. 8 is only a preferred embodiment in achieving the objectives of the present disclosure, and some steps may be added thereto or deleted therefrom as needed, and any one step may be included in another step to be performed. The order of respective operations disclosed in FIG. 8 is only arranged for convenience of understanding, and such an order is not limited to a time series order, and the order may be changed and operated differently depending on the designer's choice.

Referring to FIG. 8, when an abnormal termination occurs in a database management system, in step S3010, the apparatus 100 may scan a non-volatile memory area to retrieve a unique page number previously stored in a PPL block of the non-volatile memory and an address of a first generated PPL block so as to reconstruct a lookup table, which is an in-memory hash table that stores the retrieved unique page number and a pointer specifying the address of the first generated PPL block as a key-value pair, in the volatile memory.

In step S3020, the apparatus 100 may check the lookup table based on a unique page number of the abnormally terminated page to distinguish whether the abnormally terminated page is a normal page or a PPL page.

In step S3030, the apparatus 100 may perform recovery of the abnormally terminated page using a redo log or PPL based on the distinguishment in the previous step.

Specifically, when the abnormally terminated page is a PPL page, in step S3030, the apparatus 100 may omit a redo process because all updates are already stored in the non-volatile memory in a form of PPL.

However, when a normalization operation to store an entire normalized PPL page in the storage device fails due to an abnormal termination, the apparatus 100 may recover by applying a PPL up to a point in time at which durability is guaranteed by the PPL by utilizing page_lsn in the metadata of a first PPL block stored in the non-volatile memory for the abnormally terminated PPL page, and restore an original page by applying a log of a WAL file after that point in time. Meanwhile, in the case of a normal page that has been abnormally terminated when normalization is performed and a redo log is stored in a storage device, but a PPL remains in the non-volatile memory, the apparatus 100 does not apply the PPL by identifying it with normalize_mark in the metadata of the first PPL block.

Here, the WAL file refers to a write-ahead log file stored in a storage device. Changes to a database are sequentially recorded in the WAL file, and these logs may be used to recover the database in the event of a failure.

If the abnormally terminated page is a normal page, in step S3030, the apparatus 100 may cache the normal page stored in the storage device in a buffer of the volatile memory, as in a general case, and recover it using a redo log and an undo log based on the WAL file.

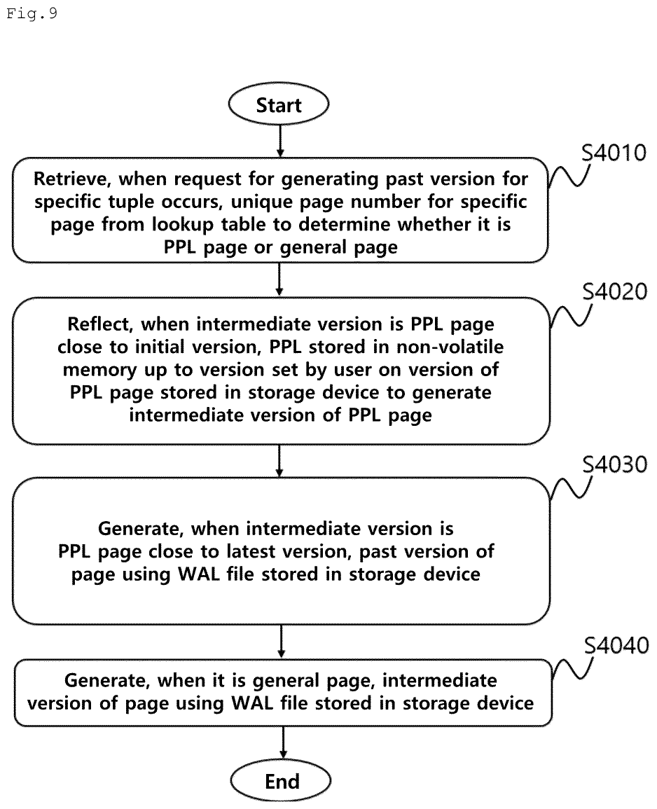

When a request for generating a past version for a specific tuple occurs in a framework according to an embodiment of the present disclosure, the apparatus 100 may perform an operation as shown in FIG. 9 below.

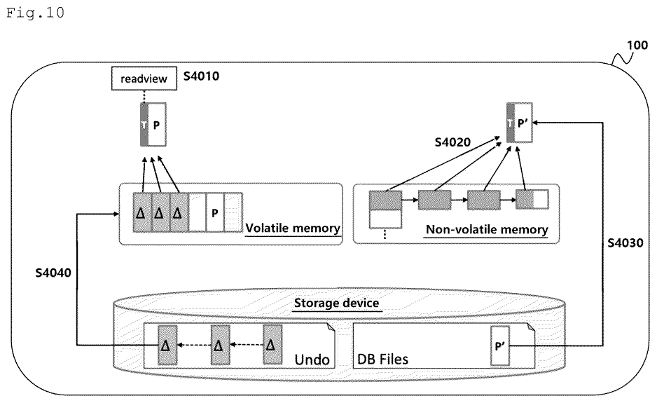

FIG. 9 is a flowchart of an operation performed by the apparatus 100 according to one embodiment when a request for generating a past version of a specific tuple occurs. FIG. 10 is a conceptual diagram simply showing a flow of data processed by the apparatus 100 according to the operation of FIG. 9. The operation of the apparatus 100 according to an embodiment in FIGS. 9 and 10 may be understood as an operation performed by the processor 120.

Each step disclosed in FIGS. 9 and 10 is only a preferred embodiment in achieving the objectives of the present disclosure, and some steps may be added thereto or deleted therefrom as needed, and any one step may be included in another step to be performed. The order of respective operations disclosed in FIGS. 9 and 10 is only arranged for convenience of understanding, and such an order is not limited to a time series order, and the order may be changed and operated differently depending on the designer's choice.

Referring to FIGS. 9 and 10, when a request for generating a past version for a specific tuple occurs, in step S4010, the apparatus 100 may retrieve a unique page number for the requested page from the lookup table to determine whether the corresponding page is a PPL page or a normal page.

If the requested page is classified as a PPL page and the requested past version is a version close to an initial version stored in the storage device, then in step S4020, the apparatus 100 may reflect a PPL stored in the non-volatile memory up to a version set by a user on a version of the PPL page stored in the storage device to generate the past version of the PPL page.

If the requested page is classified as a PPL page and the requested past version is a version close to a latest version reflecting all PPLs stored in the non-volatile memory, then in step S4030, the apparatus 100 may generate a past version of a page using a WAL file stored in the storage device as in a general case.

If the requested page is classified as a normal page, then the apparatus 100 may generate a past version of a page using a WAL file stored in the storage device, as in the general case.

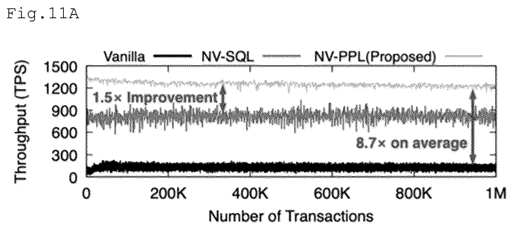

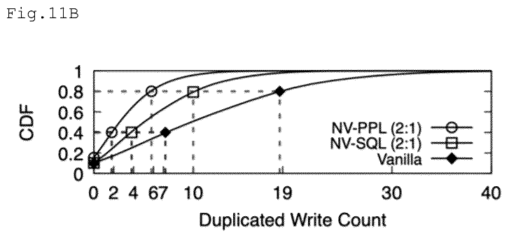

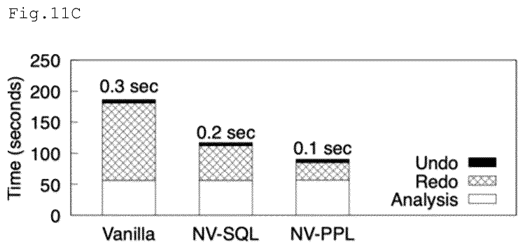

FIG. 11 is a performance comparison table comparing an existing technology and an embodiment of the present disclosure from various perspectives.
(A) of FIG. 11 shows TPS performance when Vanilla and NV-SQL, which are existing technologies, and NV-PPL, which is an embodiment of the present disclosure, are used.

Referring to (A) of FIG. 11, it can be seen that the embodiment NV-PPL of the present disclosure records a superior throughput (TPS) compared to Vanilla and NV-SQL, and specifically, shows 8.7 times higher performance on average compared to Vanilla, and has an improvement of 1.5 times compared to NV-SQL.
(B) of FIG. 11 shows a cumulative duplicated write count when Vanilla and NV-SQL, which are existing technologies, and NV-PPL, which is an embodiment of the present disclosure, are used.

Referring to (B) of FIG. 11, the embodiment NV-PPL of the present disclosure shows that a duplicated write count to the storage device occurs the least. Specifically, it can be seen that Vanilla and NV-SQL show a relatively high duplicated write count, with Vanilla recording a most duplicated write count.
(C) of FIG. 11 shows the performance of a recovery time when Vanilla and NV-SQL, which are existing technologies, and NV-PPL, which is an embodiment of the present disclosure, are used.

Referring to (C) of FIG. 11, in an analysis step, Vanilla and NV-SQL took 56 seconds, and NV-PPL took 59 seconds, and in a redo step, Vanilla took 124 seconds, NV-SQL took 56 seconds, and NV-PPL took 27 seconds. Additionally, in an undo step, Vanilla took 0.3 seconds, NV-SQL took 0.2 seconds, and NV-PPL took 0.1 seconds. Accordingly, it can be seen that the embodiment NV-PPL of the present disclosure shows a fastest recovery time and significantly reduces a period of time required for redo and undo steps.

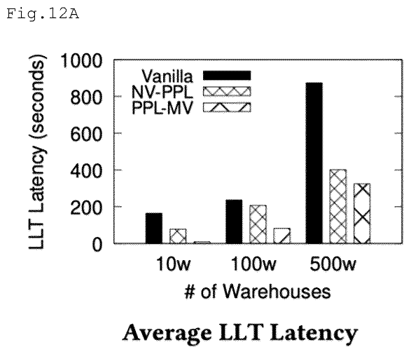

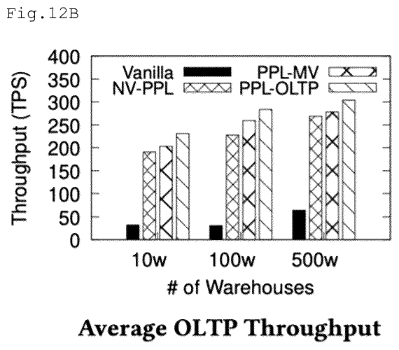

FIG. 12 is a performance comparison table comparing a long-lived transaction (LLT) latency and an online transaction processing (OLTP) throughput in systems configured with Vanilla, NV-PPL, and PPL-MV. FIG. 12 observes a performance change according to various workload sizes by expanding a number of warehouses to 10w, 100w, and 500w. In FIG. 12, Vanilla is a conventional technique, NV-PPL is a technique for managing a PPL page using a non-volatile memory among embodiments of the present disclosure, and PPL-MV is a technique for managing a PPL page using a non-volatile memory while using the embodiment of FIGS. 9 and 10 together.

Referring to (a) of FIG. 12, it can be seen that NV-PPL and PPL-MV may significantly reduce an LLT latency compared to Vanilla. In particular, Vanilla exhibits a long latency, especially as a number of warehouses increases, because its disk-based undo log and multi-version management method requires high I/O costs. On the contrary, PPL-MV efficiently generates a version by utilizing a redo log stored in an NVDIMM to reduce a latency.

Referring to (b) of FIG. 12, in an OLTP throughput comparison, NV-PPL and PPL-MV show significantly higher throughput than Vanilla. In particular, it can be seen that PPL-MV shows a high throughput even in mixed workloads by combining multi-version management and redo log-based optimization, and NV-PPL and PPL-MV stably scale performance even as a number of warehouses increases, and show outstanding throughput improvement compared to Vanilla.

As described above, according to the foregoing embodiment, the present disclosure may utilize a non-volatile memory as a durable log cache of a database management system, thereby providing the following effects.

The present disclosure may store update information of pages cached in a buffer of a volatile memory in a non-volatile memory to minimize I/O occurring in an SSD, thereby significantly improving the overall transaction processing performance of a system. This reduces I/O overhead caused by frequent database writes and extends the lifespan of an SSD, which may reduce a maintenance cost in a large-scale system such as a data center.

In addition, the present disclosure may place a redo log buffer and a double write buffer (DWB) in a non-volatile memory to ensure data durability while reducing a duplicated write count with a database. Through this, a number of I/Os performed during a process of storing data in a database may be reduced, thereby expecting an effect of shortening a transaction latency and increasing a data storage efficiency.

In addition, the present disclosure may significantly improve recovery performance. In particular, in the event of a system failure, recovery time may be minimized by utilizing redo logs stored in a non-volatile memory to omit or shorten redo and undo steps. Accordingly, the present disclosure may reduce a large number of I/O operations that occur in traditional ARIES-based recovery methods to improve recovery performance and significantly enhance system availability.

Additionally, the present disclosure may improve the performance of both OLTP and OLAP even in HTAP workloads. In particular, when caching a large amount of data such as a long-living transaction (LLT) in a volatile memory, multiple versions may be quickly generated by utilizing page-by-page redo logs stored in a non-volatile memory, thereby efficiently providing data for a past version. Through this, the present disclosure has an effect capable of minimizing interference between OLTP and OLAP queries to optimize the performance of HTAP workloads.

Accordingly, the present disclosure may reduce I/O generated from an SSD, shorten recovery time, improve transaction processing performance, extend the lifespan of the SSD, and provide performance optimized for HTAP workloads in a database system, thereby comprehensively improving the stability and performance of a database.

It should be understood that various embodiments of the disclosure and terms used herein are not intended to limit the technical features described in the disclosure to specific embodiments, and include various modifications, equivalents, or alternatives of the embodiments. With regard to the description of the drawings, similar reference numerals may be used for similar or related elements. A singular form of a noun corresponding to an item may include one or more of the things, unless the relevant context clearly indicates otherwise.

In the disclosure, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. Terms such as “1st”, “2nd”, or “first” and “second” may be used merely to differentiate a corresponding element from another, and do not limit the elements in any other aspect (e.g., importance or order). When an element (e.g., a first element) is referred to as being “coupled” or “connected” to another element (e.g., a second element), with or without the term “functionally” or “communicatively,” it means that the element may be connected to the other element directly (e.g., in a wired manner), in a wireless manner, or through a third element.

The term “module” as used in the disclosure may include a unit implemented in hardware, software or firmware, and may be used interchangeably with terms such as logic, logic block, component, or circuit. A module may be an integrally configured component or a minimum unit of the component that performs one or more functions or a part thereof. For example, according to one embodiment, the module may be implemented in a form of an application-specific integrated circuit (ASIC).

Various embodiments of the disclosure may be implemented as software (e.g., a program) including one or more instructions stored in a storage medium (e.g., a memory) that is readable by a device (e.g., an electronic device). The storage medium may include a random access memory (RAM), a memory buffer, a hard drive, a database, an erasable programmable read-only memory (EPROM), an electrically erasable read-only memory (EEPROM), a read-only memory (ROM), and/or the like.

In addition, a processor in embodiments of the disclosure may retrieve at least one instruction from among one or more instructions stored from a storage medium and execute the retrieved instruction. This allows the device to operate to perform at least one function according to the retrieved at least one instruction. The one or more instructions may include a code generated by a compiler or a code executable by an interpreter. The processor may be a general purpose processor, a field programmable gate array (FPGA), an application specific integrated circuit (ASIC), a digital signal processor (DSP), and/or the like. The device-readable storage medium may be provided in a

form of a non-transitory storage medium. Here, the term ‘non-transitory’ simply means that the storage medium is a tangible device and does not include a signal (e.g. electromagnetic waves), and this term does not differentiate between a case where data is stored semi-permanently and a case where the data is temporarily on the storage medium.

A method according to various embodiments disclosed in the disclosure may be included and provided in a computer program product. The computer program product may be traded as a commodity between a seller and a buyer. The computer program product may be distributed in a form of a device-readable storage medium (e.g., compact disc read only memory (CD-ROM)), or be distributed (e.g., downloaded or uploaded) online via an application store (e.g., PlayStore) or directly between two user devices (e.g., smartphones). In the case of online distribution, at least part of the computer program product may be at least temporarily stored or temporarily generated in the device-readable storage medium, such as a manufacturer's server, a server of an application store, or a server's memory.

According to various embodiments, each element (e.g., a module or a program) of the above-described elements may include a single entity or a plurality of entities. According to various embodiments, one or more of the aforementioned elements or operations may be omitted, or one or more other elements or operations may be added. Alternatively or additionally, the plurality of elements (e.g., modules or programs) may be integrated into a single element. In such a case, the integrated element may perform one or more functions of each of the plurality of elements in the same or similar manner to those performed by a corresponding one of the plurality of elements prior to the integration. According to various embodiments, operations performed by a module, a program or another element may be executed sequentially, in parallel, repeatedly, or heuristically, or one or more of the operations may be executed in a different order, omitted, or one or more other operations may be added.

### DESCRIPTION OF SYMBOLS

100: Apparatus
110: Memory
120: Processor
130: Input/output interface
140: Communication interface

What is claimed is:

1. A method performed by a data write minimization apparatus operated by a processor, the method comprising:
caching a page stored in a storage device into a buffer of a volatile memory;
generating, when a data update transaction occurs for the page, a PPL block including a per-page log (PPL), which is a per-page redo log, for the data update transaction in a non-volatile memory, and storing, when the PPL block grows larger than a preset size, an entire page in the storage device; and
maintaining, when a page write occurs for a PPL page in which the redo log is stored as a PPL block in the non-volatile memory, the PPL block stored in the non-volatile memory, and performing, when a page write occurs for a normal page, an entire page write to the storage device.

2. The method of claim 1, wherein the storing comprises:
storing, when a data update transaction for the page occurs a plurality of times, each PPL, which is a per-page redo log for the plurality of data update transactions, in a PPL block in an update time sequence.

3. The method of claim 1, wherein the non-volatile memory dynamically allocates a storage space of a PPL block to dynamically store a plurality of PPLs, and
wherein the PPL block comprises metadata for a page and a plurality of PPLs, which are per-page redo logs for a plurality of data update transactions.

4. The method of claim 3, wherein the meta data comprises:
a flag (first_mark) indicating a first generated PPL block for a PPL page, a flag (normalize_mark) indicating whether normalization has been performed for the PPL page, a pointer (next_block) indicating an address of a next PPL block, a total length of PPLs (PPL_len) stored in all PPL blocks, a log sequence number (page_lsn) of a latest PPL added to a current PPL block, and a unique page number (page_id) specifying a PPL page.

5. The method of claim 3, wherein the storing to the storage device comprises:
performing a normalization process of erasing, when a size of an entire PPL block for one page becomes above a preset value, all redo logs included in the entire PPL block and storing an entire page reflecting all redo logs in the storage device to change a PPL page into a normal page.

6. The method of claim 1, wherein the storing comprises:
calculating a memory allocation rate for a non-volatile memory for each PPL page at preset intervals, and performing, when the memory allocation rate exceeds a preset threshold, a normalization process of erasing, when a last update to the page occurred before a preset time, all redo logs included in an entire PPL block and storing an entire page in the storage device to change a PPL page into a normal page.

7. The method of claim 6, wherein the preset time of the last update for the page is calculated according to Equation 1 below:
$$\frac{Pages per MB of Memory}{IOPS of Disk} \times \frac{Disk Price}{Memory Price per MB} \qquad [ Equation 1 ]$$
(Pages per MB of Memory: A number of pages that can be cached per 1 MB of memory, IOPS of Disk: A number of input/output operations that a disk can process per second, Disk Price/Memory Price per MB: A cost-performance efficiency between a disk and a memory).

8. The method of claim 1, wherein the storing comprises:
generating a lookup table, which is an in-memory hash table that stores a unique page number specifying a PPL page and a pointer specifying an address of a first generated PPL block as a key-value pair, in the volatile memory.

9. The method of claim 8, wherein the generating of the lookup table comprises:
adding, when a normal page is PPLized to become a PPL page, a unique page number specifying the PPL page and a pointer to the first generated PPL block to the lookup table.

10. The method of claim 8, wherein the method further comprises:
retrieving, when a read transaction occurs for a specific page, a unique page number for the specific page in the lookup table to determine, when the unique page number exists in the lookup table, the specific page as a PPL page, and determine, when the unique page number does not exist, the specific page as a normal page.

11. The method of claim 1, wherein the storing performs a double write buffer technique that doubly stores entire updated page contents in a buffer of the non-volatile memory and in the storage device.

12. The method of claim 1, wherein the method further comprises:
generating, when a read transaction occurs for the PPL page, a latest version of the PPL page reflecting the PPL stored in the non-volatile memory on a version of the PPL page stored in the storage device to cache it in a buffer of the volatile memory.

13. The method of claim 12, wherein the generating of the latest version of the PPL page to cache it in a buffer of the volatile memory comprises:
reflecting a PPL stored in the PPL block in a time sequence on a version of the PPL page stored in the storage device to generate a latest version of the PPL page.

14. The method of claim 1, wherein the method further comprises:
distinguishing, when an abnormal termination occurs, whether the abnormally terminated page is a normal page or a PPL page, to perform recovery.

15. The method of claim 14, wherein the performing of the recovery comprises:
retrieving a unique page number previously stored in a PPL block of the non-volatile memory and an address of a first generated PPL block to reconstruct a lookup table, which is an in-memory hash table that stores the retrieved unique page number and a pointer specifying the address of the first generated PPL block as a key-value pair, in the volatile memory;
checking the lookup table based on a unique page number of the abnormally terminated page to distinguish whether the abnormally terminated page is a normal page or a PPL page; and
performing recovery of the abnormally terminated page using a redo log or PPL based on the distinguishment.

16. The method of claim 15, wherein the performing of recovery of the abnormally terminated page comprises:
updating, when a normalization operation to store an entire normalized PPL page in the storage device fails due to an abnormal termination, the abnormally terminated PPL page by applying a latest PPL starting from a first PPL stored in the non-volatile memory, and restoring an original page by applying a log of a WAL file from a point in time after the latest PPL.

17. The method of claim 1, wherein the method comprises:
reflecting, when a request for generating a past version of a PPL page occurs, a PPL stored in the non-volatile memory up to a version set by a user on a version of the PPL page stored in the storage device to generate the past version of the PPL page.

18. The method of claim 1, wherein the method comprises:
generating, when a request for generating an intermediate version of a PPL page occurs, a past version of a page using a WAL file stored in the storage device.

19. A data write minimization apparatus, the apparatus comprising:
a memory including an instruction; and
a processor that performs a predetermined operation based on the instruction,
wherein the operation of the processor comprises:
caching a page stored in a storage device into a buffer of a volatile memory;
generating, when a data update transaction occurs for the page, a PPL block including a per-page log (PPL), which is a per-page redo log, for the data update transaction in a non-volatile memory, and storing, when the PPL block grows larger than a preset size, an entire page in the storage device; and
maintaining, when a page write occurs for a PPL page in which the redo log is stored as a PPL block in the non-volatile memory, the PPL block stored in the non-volatile memory, and performing, when a page write occurs for a normal page, an entire page write to the storage device.

20. A computer program stored in a non-transitory computer-readable recording medium, the computer program comprising:
when performed on at least one processor,
an instruction that allows the processor to perform:
caching a page stored in a storage device into a buffer of a volatile memory;
generating, when a data update transaction occurs for the page, a PPL block including a per-page log (PPL), which is a per-page redo log, for the data update transaction in a non-volatile memory, and storing, when the PPL block grows larger than a preset size, an entire page in the storage device; and
maintaining, when a page write occurs for a PPL page in which the redo log is stored as a PPL block in the non-volatile memory, the PPL block stored in the non-volatile memory, and performing, when a page write occurs for a normal page, an entire page write to the storage device.
